(19) United States
(12) Patent Application Publication
(10) Pub. No.: US 2010/0072682 A1
(43) Pub. Date: Mar. 25, 2010

(54) MINI TORCH WITH TORCH HOLDER AND TORCH ADAPTER

(76) Inventors: Jonah Winfield, III, Lorain, OH (US); Patsie C. Campana, JR., Lorain, OH (US)

Correspondence Address: FAY SHARPE LLP, 1228 Euclid Avenue, 5th Floor, The Halle Building, Cleveland, OH, 44115, US

(21) Appl. No.: 12/515,713

(22) PCT Filed: Nov. 30, 2007
(86) PCT No.: PCT/US07/86074

§ 371 Date: May 20, 2009

Related U.S. Application Data
(60) Provisional application No. 60/863,037, filed on Oct. 26, 2006.
(60) Provisional application No. 60/896,399, filed on Mar. 22, 2007.

(51) Int. Cl. B23K 7/10; F16M 13/00; F23D 14/48

(52) U.S. Cl. 266/77; 248/314; 239/589

(57) ABSTRACT

An exothermic mini torch includes a torch holder assembly for holding a consumable thermal torch. The torch holder assembly includes a body defining a recess into which the consumable thermal torch is inserted. A passage is defined in the body having a first end fluidly connected to the gas source and a second end fluidly connected to the recess for delivering gas from the gas source to the consumable thermal torch. A filter is optionally disposed between the gas source and the consumable thermal torch adjacent the second end of the passage for filtering the gas and preventing backflow of the gas into the body. A seal is received in the recess and is optionally annularly disposed between an outer circumferential surface of the consumable thermal torch and a portion of the body forming the recess to direct the gas into the consumable thermal torch.

This application claims priority from U.S. provisional application Ser. No. 60/869,037 filed Dec. 7, 2006 and Ser. No. 60/896,399 filed Mar. 22, 2007, both fully incorporated herein by reference.

### BACKGROUND

The present disclosure generally relates to an improved mini torch and torch adapter with a torch holder assembly. More particularly, the present disclosure relates to an improved exothermic mini torch, an improved torch holder assembly for holding a consumable thermal torch, and a conversion nozzle for converting a conventional dual-gas cutting torch into a single-gas exothermic cutting torch.

One known exothermic mini torch is the Caldo Mini Cutting Torch offered for sale by Caldo Torch of Lorain, Ohio, a subsidiary of P.C. Campana, Inc., also of Lorain, Ohio. The Caldo Mini Cutting Torch provides an efficient and inexpensive tool for gouging, piercing and/or cutting through any metallic, nonmetallic and/or composite material. The Caldo Mini Torch employs one or more features, and/or can be used in conjunction with the torches and methods, described in U.S. Pat. Nos. 4,660,807; 4,114,863; and 5,000,426, all fully incorporated herein by reference.

More particularly, the Caldo Mini Cutting Torch operates on a single gas, such as oxygen. The torch delivers the single gas, under pressure (e.g., about 60-75 psi or 4-5 bar), to and through an exothermic rod or consumable thermal torch. Inner components of the rod burn at a faster rate than outer components of the rod creating a shroud effect and yielding a much hotter, directed burn as compared to other conventional exothermic torches. As a result, the Caldo Mini Torch is able to cut, burn, melt or vaporize virtually all metallic, nonmetallic and composite materials and does so while being capable of being manufactured at a much reduced amount when compared to other exothermic cutting systems. Advantageously, the outer component, also referred to as a parent metal, experiences relatively low temperatures. Moreover, with the Caldo Mini Torch, warpage, loss of tensile strength and/or metal fatigue are not experienced. Still further, repairs can be made to a work product without raising burrs on main frames and final drives because the torch operates without electrical continuity.

FIG. 4 schematically shows a consumable thermal torch, such as taught in the '863 patent, being held in a cutting torch, such as a prior art Caldo Mini Cutting Torch. More particularly, torch A is received in a recess B defined in a torch body C. A passage D delivers a single gas to the consumable torch A. A seal E, in the form of a rubber washer, seals between the torch A and the body C and thereby directs gas from the passage D into the torch A. The consumable torch A is held in the recess B and sealing action of the seal E maintained by a collet F contracting onto the consumable torch A due to engagement with a cap G threaded onto the body C.

While the Caldo Mini Torch has been a very commercially successful product, any improvements that improve performance and/or operational safety of the torch are considered desirable.

Of course, many other types of cutting torches are available and well known. One ubiquitous cutting torch is the conventional two-gas cutting torch, which typically employs oxygen and some other fuel source, such as acetylene. These types of torches are often referred to as acetylene torches or oxy-acetylene torches and can be used in a variety of applications. For example, the torch can be used to braze various components to one another. These torches can also be used simply as cutting torches and/or for heating up a work piece, such as for shaping a metal work piece or TIG welding a heated metal piece.

A typical oxy-acetylene torch includes a first gas source, such as a cylinder of compressed oxygen, and a second fuel gas source, such as a cylinder of compressed acetylene gas. Flexible hoses direct gases from the cylinders to a nozzle or torch, wherein the gases are ignited. Of course, pressure regulators can be used in association with the gas cylinders. Within the nozzle, the two-gases (such as oxygen and acetylene) are mixed together for purposes of producing a high temperature flame from the nozzle. A conventional nozzle for an oxy-acetylene torch includes a central passageway for directing pure oxygen from one end of the nozzle to an opposite end and additional axial passageways circumferentially disposed about the central passageway. The additional passageways usually include branch portions for receiving oxygen and acetylene gases and mixing the same prior to delivery of the mixed gases to the opposite end of the torch.

### SUMMARY

According to one aspect, an improved exothermic mini torch is provided. More particularly, in accordance with this aspect, the improved exothermic mini torch includes a body defining a passage through which gas from a gas source passes to a consumable thermal torch. A filter is disposed adjacent one end of the passage and adjacent the consumable thermal torch for filtering gas passing thereby and preventing backflow into the body.

According to another aspect, an exothermic mini torch is provided. More particularly, in accordance with this aspect, the exothermic mini torch includes a torch holder assembly for holding a consumable thermal torch. The torch holder assembly includes a body defining a recess into which the consumable thermal torch is inserted. A passage is defined in the body having a first end fluidly connected to a gas source and a second end fluidly connected to a recess for delivering gas from the gas source to the consumable thermal torch. A filter is disposed between the gas source and the consumable thermal torch adjacent the second end of the passage for filtering the gas and preventing backflow of the gas into the body.

According to still another aspect, an improved torch holder assembly is provided for holding a consumable thermal torch. More particularly, in accordance with this aspect, the torch holder assembly includes a body defining a passage through which gas from a pressure source passes to a recess formed in the body. One end of the consumable thermal torch is received in the recess for receiving the gas passing thereto. A seal is annularly disposed between an outer circumferential surface of the consumable thermal torch and a portion of the body forming the recess to direct the gas into the consumable thermal torch.

According to yet another aspect, a torch holder assembly is provided for holding a consumable thermal torch. More particularly, in accordance with this aspect, the torch holder assembly includes a body defining a recess into which one end of the consumable thermal torch is received. A passage is defined through the body including a first end fluidly connected to a gas source and a second end fluidly connected to the recess for delivering gas from the gas source to the consumable thermal torch. A seal is received in the recess and is annularly disposed between an outer circumferential surface of the consumable thermal torch and a portion of the body forming the recess to direct the gas into the consumable thermal torch.

According to still yet another aspect, a conversion nozzle or tip is provided. More particularly, in accordance with this aspect, the conversion nozzle or tip includes a body adapted to be received within a conventional two-gas cutting torch. The body defines a passageway for allowing one of two gasses (e.g., oxygen) from the torch to flow therethrough to a consumable thermal torch while blocking the other of the two gasses (e.g., acetylene).

According to a further aspect, a conversion nozzle is provided for converting a two-gas torch to a single gas exothermic torch. More particularly, in accordance with this aspect, the conversion nozzle includes a body portion having a first end portion configured to be removably secured in a torch tip recess of a two-gas torch and a second end portion configured to hold a consumable thermal torch. A nozzle passage extends from the first end portion to the second end portion for transmitting one gas of the two-gas torch to the consumable thermal torch while preventing another gas of the two-gas torch from reaching the consumable thermal torch.

### BRIEF DESCRIPTION OF THE DRAWINGS

FIG. 1 is an exploded view of an improved exothermic mini torch.

FIG. 2 is a partial cross-sectional view of the exothermic mini torch of FIG. 1 showing a torch holder assembly thereof holding a consumable thermal torch.

FIG. 3 is a partial cross-sectional view of the torch holder assembly taken along the line 3-3 of FIG. 2.

FIG. 4 is a partial cross-sectional view similar to FIG. 2, but of a prior art torch holder assembly holding a consumable thermal torch.

FIG. 5 is a is a partial cross-section view similar to FIG. 2, but of an alternate torch holder assembly for holding a consumable thermal torch.

FIG. 6 is an exploded perspective view of select components of the torch holder assembly of FIG. 5, including a grommet and a press ring.

FIG. 7 is a side elevational view of a conversion nozzle for converting a two-gas torch into a single-gas exothermic torch.

FIG. 8 is a cross-sectional view of the nozzle of FIG. 7 taken along the line 8-8.

FIG. 9 is a cross-sectional view of the improved nozzle of FIG. 7 installed on a conventional two-gas cutting torch, such as an oxy-acetylene cutting torch.

### DETAILED DESCRIPTION

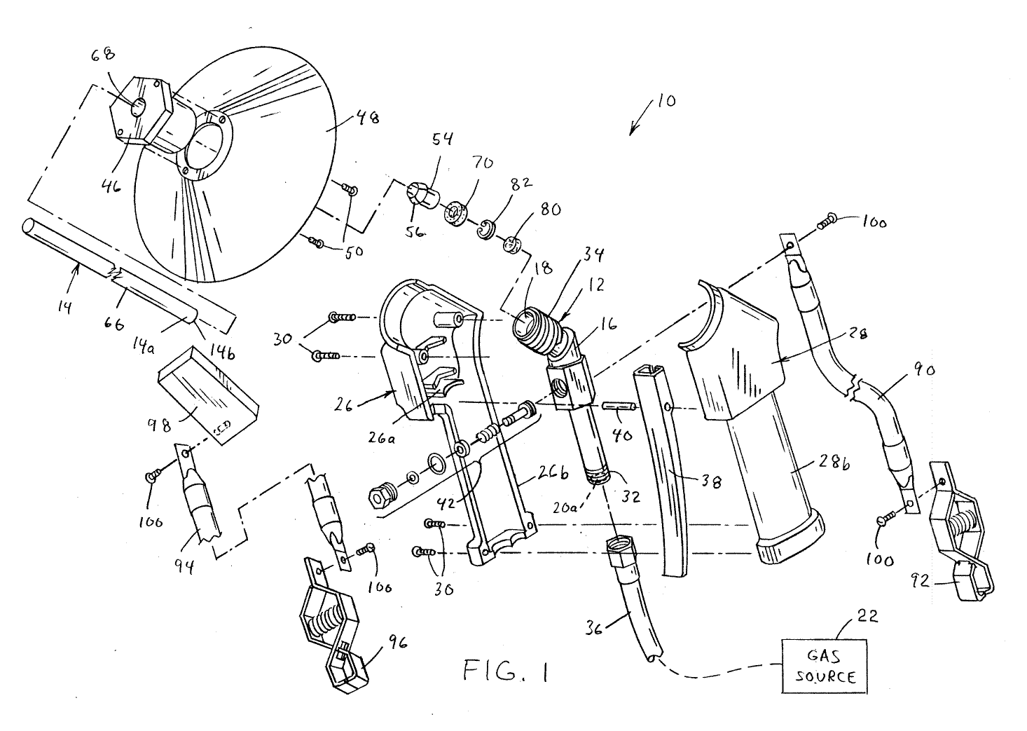

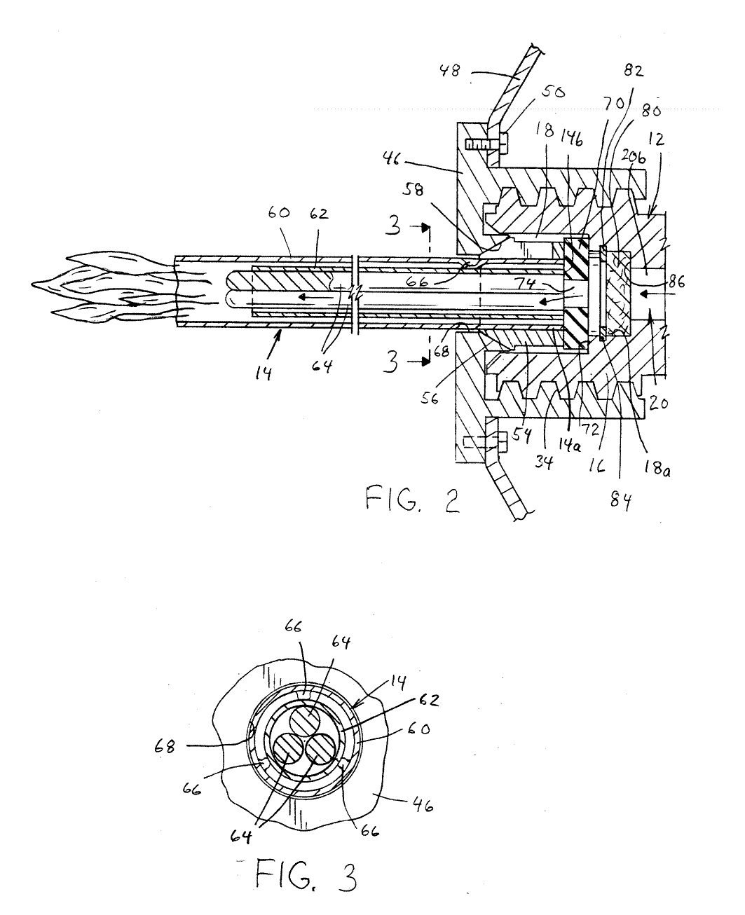

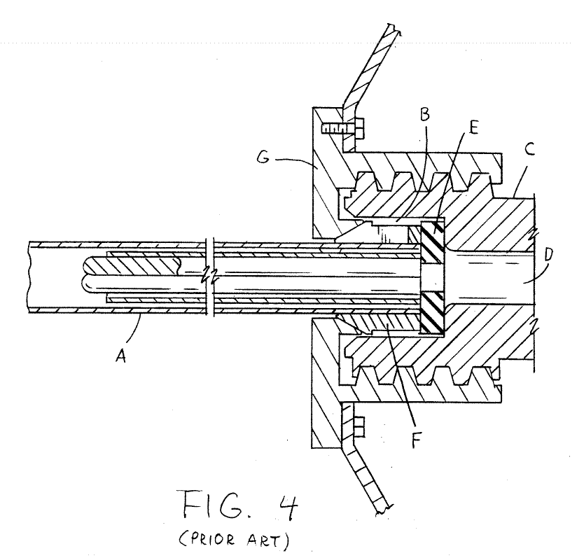

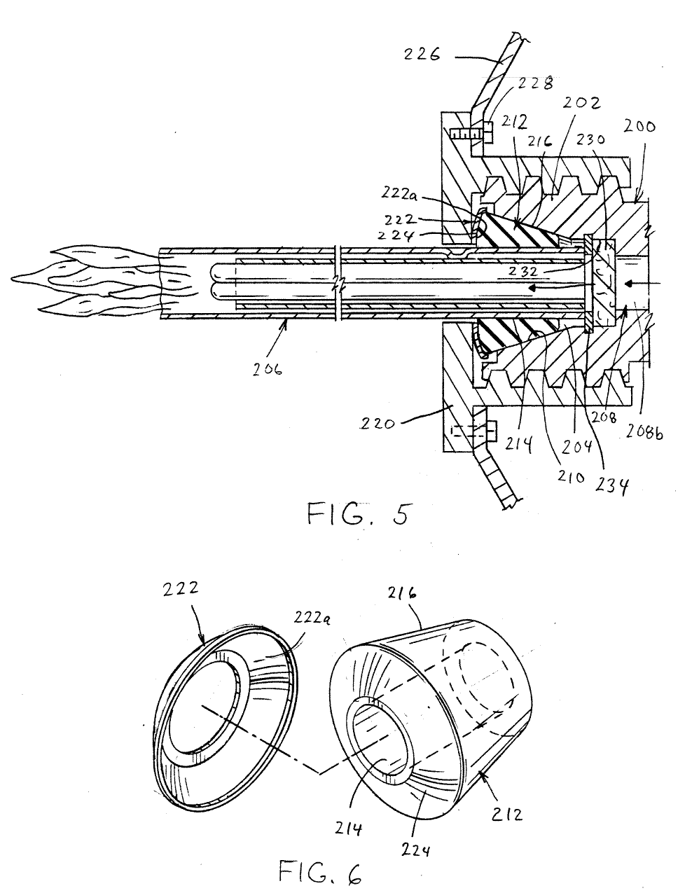

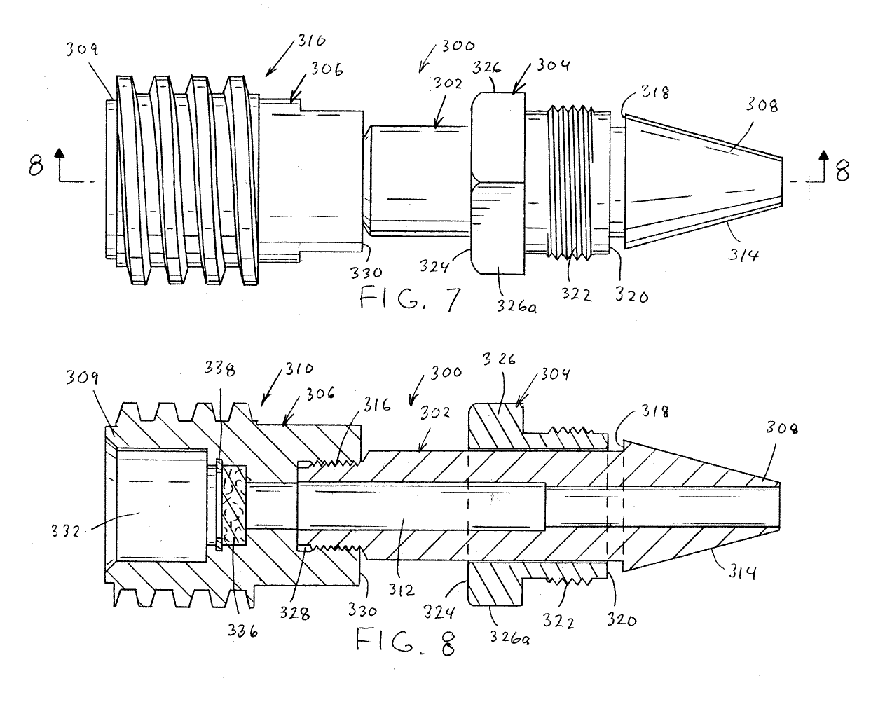

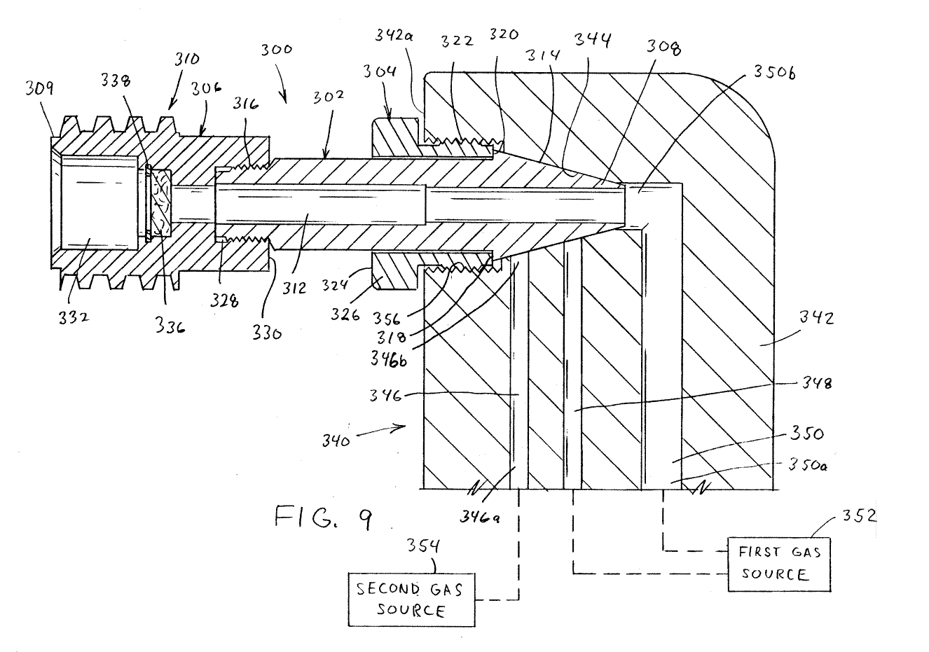

Referring now to the drawings wherein the showings are for purposes of illustrating one or more exemplary embodiments, FIGS. 1 and 2 illustrate an improved exothermic torch that is generally indicated by reference numeral 10. The illustrated torch 10 includes a torch holder assembly 12 for holding a consumable thermal torch 14. The torch holder assembly 12 includes a body 16 (or at least a portion of a body) defining a recess 18 into which the consumable thermal torch 14 is inserted. A passage 20 defined in the body 16 has a first end 20a fluidly connected to a gas source 22 and a second end 20b fluidly connected to the recess 18 for delivering gas from the gas source 22 to the consumable thermal torch 14.

The body 16 is housed between outer body member halves 26,28 which can be secured together via suitable fasteners, such as the illustrated body screws 30. In particular, the body 16, which can be formed of brass, is secured in position between the body member halves 26,28 by raised structures (e.g., raised structure 26a) integrally formed with the body member halves 26,28. The body member halves 26,28 can be formed of a thermal plastic which can serve to insulate the body 16 from a user holding the body member halves 26,28 when using the torch 10. The arrangement of the body member halves 26,28 and the body 16 can be such that handle portions 26b,28b of body member halves 26,28 are arranged at a preferred angle relative to an axial direction of the recess 18 (e.g., 45°) which can provide for ease of operation and less fatigue of an operator when continuous or long use of the torch 10 is required. In addition, the handle portions 26b,28b, can be molded so as to conform to the user's hand and provide a comfortable grip.

The body 16 itself can include a lower threaded end 32 and an upper threaded end 34. The passage 20 extends between the lower threaded end 32 and the upper threaded end 34. A hose and fitting assembly 36 threadedly connects to the lower end 32 of the body 16 for delivering gas (e.g., oxygen) from the gas source 22, which can be a cylinder tank, to the torch, and in particular the torch body 16. More specifically, gas from the gas source 22 is directed from the lower threaded end 32 to the upper threaded end 34 through the body 16 to the recess 18. Such flow is controlled or regulated by lever 38 which can be pivotally mounted via lever pin 40 received between the body members or halves 26,28. The lever 38 serves as an actuator member which functions in conjunction with high pressure seat and valve assembly 42 disposed within the body 16. The seat and valve assembly 42 can include appropriate components (such as those illustrated) for regulating the flow of gas from the lower threaded end 32 through the passage way 20 to the upper threaded end 34 of the body 16 and thus regulates gas flow through the torch 10.

More particularly, the valve assembly 42 can include a valve disposed within the passage 20 for regulating the flow of gas from the gas source 22 thereby. The valve can be movable by the lever 38 between a first position in which flow of the gas through the passage 20 is prevented and a second position in which flow of the gas through the passage is substantially unrestricted by the valve member. The lever 38, also referred to herein as a movable lever actuator, can move the valve member between its first and second positions or can allow the valve member to be held at an intermediate position between the first and second positions for allowing a controlled amount of the gas to pass thereby.

The torch holder assembly 12 further includes a threaded member or nut 46, also referred to herein as a cap. A threaded member 46 can be selectively threadedly received on the upper threaded end 34 of the body 16. In addition to holding the consumable thermal torch 14 as part of the torch holder assembly 12, the nut 46, which can be a brass collet nut, can be used to secure a shroud or shield 48 to the upper threaded end 34 of the body 16. More particularly, in the illustrated embodiment, threaded members or shield screws 50 secure the shield 48 to the nut 46 such that, when the nut 46 is threadedly received on the upper threaded end 34 of the body 16, the shield 48 is also secured to the body 16. The shield 48 can be formed of steel and is provided, at least in part, for protection of an operator's hand from extreme heat and blow back.

In the embodiment illustrated in FIGS. 1 and 2, the torch holder assembly 12 further includes a collet 54 that can be annularly received about the consumable thermal torch 14. As illustrated, the collet 54 includes a tapered surface 56 adjacent an open end of the recess 18. The threaded retaining member 46 includes a corresponding tapered surface 58 that acts on the collet tapered surface 56 as the threaded retaining member 46 is threaded onto the body 16 to cause the collet 54 to radially contract on the consumable thermal torch 14 to fixedly secure the torch 14 to the body 16.

The consumable thermal torch 14 can be one of the torches or lances disclosed in U.S. Pat. Nos. 4,114,863; 4,660,807; and/or 5,000,426, the disclosures of which are fully incorporated herein by reference. In the illustrated embodiment, the torch 14 is shown as being the same or similar to the one shown in FIGS. 1-3 of the '863 patent. Thus, with additional reference to FIG. 3, the torch 14 has an outer sleeve or casing 60, an inner sleeve or casing 62 and a plurality of burning rods 64. Detents 66 can be employed to maintain the casings 60,62 in a spaced apart concentric arrangement, as illustrated.

When desirable to install the thermal torch 14 in the torch 10, one end 14a of the torch 14 is received in the recess 18 defined in the upper threaded end 34 of the body 16 for receiving gas passing through the passage 20. The consumable thermal torch 14 is also passed through the collet 54 and an aperture 68 defined in the nut 46. With the collet 54 disposed in the recess 18 axially, threadedly installing the nut 46 onto the upper threaded end 34 causes the collet 54 to radially compress onto the torch 14 and thereby hold the torch 14 to the body 16. More specifically, the tapered structure or surface 58 of the nut 46 cooperates and engages with the tapered surface 56 of the collet 54 to radially compress or contract the collet 54 onto the consumable thermal torch 14 as the nut 46 is threadedly advanced onto the upper threaded end 34.

An annular seal 70 is disposed between the consumable thermal torch 14 and the body 16 to direct the gas from the passage 20 into the consumable thermal torch 14. In the embodiment illustrated in FIGS. 1 and 2, the annular seal 70 is a rubber washer disposed axially between an end edge 14b of the consumable thermal torch 14 and a shoulder 72 of the body 16 partially defining the recess 18. The seal 70 has an aperture 74 defined therethrough so that gas passed from the passage 20 to the recess 18 is directed into the torch 14.

A filter 80 is disposed between the gas source 22 and the consumable thermal torch 14 adjacent the second end 20b of the passage 20 for filtering the gas and preventing back flow into the body 16. More particularly, the filter 80 is disposed approximately at a location disposed axially between the recess 18 and the second end 20b of the passage 20 to filter all of the gas flowing from the passage 20 into the recess 18. In one embodiment, the filter 80 is a brass filter. The filter advantageously prevents back flow into the body 16 by filtering any dirt, debris, etc. attempting to enter the torch body 16 from the recess 18.

In the illustrated embodiment, the recess 18 includes an axially inward portion 18a disposed immediately adjacent the second end 20b of the passage 20. The filter 80 is cooperatively received in the axially inward portion 18a and secured therein by a locking device 82. The locking device 82 can include or be a snap ring removably secured in a corresponding groove 84 to axially lock the filter 80 in the axially inward portion 18a of the recess 18 against a shoulder 86 partially defining the axially inward portion 18a. As shown, the filter 80 can have a diameter that substantially matches a diameter of the axially inward portion 18a to allow the filter 80 to be cooperatively disposed in the axially inward portion 18a. The filter 80 serves two primary functions. First, it filters the gas (e.g., oxygen) passing therethrough. Second, it prevents back flow from the thermal lance 14 into the torch body 16, which eliminates the need for an external back flow device (e.g., an anti-blow back valve).

For igniting the torch 10 when an appropriate thermal lance is secured thereto (such as torch 14), a power connection assembly is provided. More particularly, with specific reference to FIG. 1, a cable 90 can be provided for electrically connecting the body 16 to one terminal of a conventional DC battery (e.g., a 12 Volt DC battery). As illustrated, the cable 90 can have a battery clamp 92 disposed on one end thereof for facilitating connection to the battery. A second cable 94 can be connected to an opposite terminal of the battery and can be connected thereto by battery clamp 96. An opposite end of the cable 94 can be secured to a striker plate 98, which is used for igniting the torch 10 selectively by an operator thereof as is known and understood by those skilled in the art. As shown, suitable fasteners, such as screws 100, can be used for securing the cables to the clamps 92,96 and, respectively, the body 16 and the striker plate 98. Alternatively, an igniter tube or other igniter device or means can be used for igniting the torch 10.

With reference to FIGS. 5 and 6, a torch holder assembly 200 is shown for holding a consumable thermal torch or a lance in accordance with an alternate embodiment. The torch holder assembly 200 is similar to the holder assembly 12 discussed hereinabove except as indicated below. The torch holder assembly 200 includes a body 202 (or a portion of a body) defining a recess 204 into which one end of a consumable thermal torch 206 can be received. The torch 206 can be the same or similar to the torch 14 described hereinabove. The torch holder assembly 200 additionally includes a passage 208 defined through the body 202. The passage 208 can be the same as the passage 18 of the torch holder assembly 12 and thus can include a first end (not shown) fluidly connected to a gas source and a second end 208b fluidly connected to the recess 204 for delivering gas from the gas source to the consumable thermal torch 206.

The body 202 and recess 204 vary from the corresponding body 16 and recess 18 in that the recess 204 has a tapered sidewall 210. Instead of the arrangement employing collet 54 and seal washer 70, the torch holder assembly 200 includes a seal 212 received in the recess 204 and annularly disposed between an outer circumferential surface 214 of the consumable thermal torch 206 and a portion of the body 202 forming the recess 204 (i.e., the tapered sidewall 210) to direct gas from the passage 208 into the consumable thermal torch 206.

More particularly, the seal 212, also referred to herein as a grommet, includes a tapered outer surface 216 that cooperates with the tapered surface or wall 210 of the body 202. Thus, as best shown in FIG. 5, the seal 212 is annularly disposed between the outer circumferential surface 214 of the torch 206 received in the recess 204 and a portion of the body 202 forming the recess to direct gas into the consumable thermal torch 206.

The torch holder assembly 200 further includes a threaded retaining member 220, which can be similar to the nut 46, but does not require the tapered structure or surface 58 thereof. As shown, the threaded retaining member 220 can be threadedly received on the body 202. The threaded retaining member 220 can apply an axial force on the seal 212 as it is threaded onto the body 202. A tapered engagement between the seal 212 and the body 202 forces the seal 212 to radially grip onto the outer circumferential surface 214 when the axial force is applied to the seal 212 by the threaded retaining member 220. Particularly, the tapered engagement is formed between the tapered outer surface 216 of the seal 212, which can also be referred to as a tapered radial side, and the cooperating tapered sidewall 210, which can be referred to as a tapered radial surface, of the body 202 forming the recess 204.

In the illustrated embodiment, the seal 212 is a resilient or rubber grommet and the torch holder assembly further includes a non-resilient press ring, such as steel or stainless steel press ring 222, though this is not required. When assembled to hold the thermal torch 206, the press ring 222 is disposed axially between the threaded retaining member 220 and the resilient grommet 212. Specifically, the press ring 222 is disposed axially adjacent the rubber grommet 212 on a side thereof opposite the passage 208. When assembled, the threaded retaining member 220 pushes against an axial side of the rubber grommet 212 which causes the tapered radial surface 210 of the body 202 to act on the tapered radial side 216 of the grommet 212 to cause the grommet 212 to radially contract on the consumable thermal torch 206 to fixedly secure the consumable thermal torch to the body 202 as the threaded retaining member 220 is threaded onto the body 202.

In other words, when the threaded retaining member 220 is threadedly installed onto the threads of the body 202, the threaded retaining member 220 exerts and axial force against the press ring 222 which, in turn, exerts an axial force onto an outward facing surface or axial surface 224 of the rubber seal 212. The cooperation between the seal 212 and the body 202 (i.e., the tapered engagement) causes the seal 212 to radially contract or constrict so as to grasp and hold the torch 206 to the body 202. In the illustrated embodiment, the axial surface 224 of the seal 212 is a curved surface against which the press ring 222 is disposed and the press ring 222 includes a matching curved surface 222a that distributes the axial force from the threaded retaining member 220 across the curved axial surface 224 of the seal 212.

Unlike the seal 70 of the torch holder assembly 12, the seal 212 of the torch holder assembly 200 seals against and grips the outer circumferential surface 214 of the torch 206. Such an arrangement ensures that all gas passing from the passage 208 into the recess 204 is directed into the torch 206. Whereas the annular washer seal 70 must be ensured to provide a good seal against the inserted end 14b of the torch 14, the torch holder 200 has no such requirement because the seal action occurs against the outer circumferential surface 214 of the torch 206. In addition, while attention need be paid to the size of the aperture, such as aperture 74, in the annular washer seal 70 to ensure that the size of the aperture causes all gas received from passage 20 to be directed into the torch 14, the torch holder 200 of FIGS. 5 and 6 does not have a washer with an aperture disposed axially between the end of the torch 206 and the passage 208.

In most or all other aspects, operation of the holding device 200 and its components or elements, occurs in the same or similar fashion as described in reference to the holder assembly 12. For example, a shroud 226 can be secured to the threaded member 220 by fasteners 228 the same as shroud 48 is secured to threaded member 46 by fasteners 50. Additionally, for example, body 202 can have a filter 230 received in an axially inward portion 232 of recess 204 and held in position by a snap ring 234.

With reference now to FIGS. 7 and 8, a conversion nozzle or tip 300 is illustrated for converting a conventional two-gas cutting torch into a single-gas exothermic torch. The conversion nozzle 300 includes a body, including portions 302,304,306, having a first end portion 308 configured to be removably secured in a torch tip recess of a two-gas torch and a second end portion 309 configured to hold a consumable thermal torch, such as the torch 14. The nozzle 300 further includes a nozzle passage 312 extending from the first end portion 308 to the second end portion 309 for transmitting one gas of a two-gas torch to a consumable thermal torch while preventing another gas of the two-gas torch from reaching the consumable thermal torch, as will be described in further detail below.

More particularly, the body portion is formed of an inlet stem 302, a tip nut 304, and a torch holder body 306. The inlet stem 302 has a first tapered end 314 at least partially forming the first end portion 308 and a second threaded end 316. As will be described in more detail below, the tapered end 314 is received within a torch tip recess of a conventional two-gas cutting torch and serves to block delivery of at least the fueling gas, and possibly low pressure delivery of cutting gas, while allowing delivery of high pressure cutting gas, such as oxygen. Adjacent the tapered portion 314, the inlet stem 302 includes a shoulder 318. The inlet stem 302 forms at least a portion of the nozzle passage 312, which extends along an entire axial extent of the inlet stem 302.

The tip nut 304 is annularly received about the inlet stem 302 between its ends 314,316. The tip nut 304 includes a first end 320 that selectively engages the shoulder 318 for securing the inlet stem 302 in an associated two-gas cutting torch as will be described in more detail below. The tip nut 304 also includes an external threaded region 322 disposed generally adjacent the first end 318. Adjacent a second end 324 of the tip nut 304 is a radially enlarged head portion 326 which can include tool engaging surfaces 326a (e.g., a hex head with flat surfaces) for facilitating rotation of the tip nut 304 by an appropriate tool (e.g., a wrench).

The second threaded end 316 of the inlet stem 302 is adapted to threadedly engage the torch holder body 306. More particularly, the torch holder body 306 of the illustrated embodiment includes a recess 328 adjacent a first end 330 which is internally threaded for threaded receipt of the inlet stem 302, particularly the second threaded end 316 of the inlet stem.

The second end portion 309 of the conversion nozzle 300 includes or forms a torch holder assembly 310 for holding a consumable thermal torch. Except as noted herein, the illustrated torch holder assembly 310 is the same or similar to the torch holder assembly 12 of FIGS. 1 and 2. Like the torch holder assembly 12, the torch holder assembly 310 can employ an annular seal, such as seal 70, disposed between a consumable thermal torch received in the recess 332 and the torch holder body 306 to direct the one gas passing through the nozzle passage 312 into the consumable thermal torch.

Additionally, as shown, the torch holder assembly 310 can include a brass filter 336 disposed approximately at a location disposed axially between the recess 332 and an end of the nozzle passage 312 to filter the gas flowing through the nozzle passage 312 into the consumable thermal torch and preventing back flow thereof. Like the torch holder assembly 12, the filter 336 can be received in an axially inward portion of the recess 332 and held in place by a snap ring 338. The illustrated torch holder assembly 310 can be used with a collet, such as collet 54 and a nut, such as nut 46, so as to form the holder assembly shown and described in reference to FIGS. 1 and 2. In this manner, the holder assembly 310 can be used to secure a consumable thermal torch or lance, such as torch 14, to the conversion tip 300. Such an arrangement allows thermal torches or lances to be used in the conversion nozzle 300 and, as described in more detail below, used with any torch in which a conversion nozzle is installed. Alternately, the torch holder assembly 310 can be configured like the torch holder assembly 200 (i.e., employing a tapered seal radially between a consumable torch and the torch holder body 306).

With additional reference to FIG. 9, the conversion nozzle 300 can be received within a two-gas cutting torch, such as depicted torch 340, which can be an oxy-acetylene torch. The torch 340 includes a two-gas torch body 342 defining a torch tip recess 344. More particularly, the torch tip recess 344 can have a tapered configuration that is substantially matched by the first tapered end 314 of the inlet stem 302. The recess 344 is in fluid communication with a series of passages 346, 348, and 350.

As is known and understood by those skilled in the art, the passages 346,348,350 fluidly communicate with one or more gas sources, which can include a fuel source, such as acetylene gas, and a cutting gas source, such as oxygen. For example, the passage 350, which can be referred to as a first passage, is defined in the body 342 with a first end 350a fluidly connected to a first gas source 352 for receipt of a first gas and a second end 350b fluidly connected to the torch tip recess 344 for delivering the first gas from the first gas source 352 (e.g., oxygen) to the torch tip recess 344. The body (including portions 302,304,306) of the conversion nozzle 300 delivers the first gas from the first gas source 352 to a consumable thermal torch held in the recess 332 via the nozzle passage 312.

The passage 346, which can be referred to as a second passage, is defined in the body 342 with a first end 346a fluidly connected to a second gas source 354 for receipt of a second gas and a second end 346b fluidly connected to the torch tip recess 344 for delivering the second gas from the second gas source 354 (e.g., acetylene) to or toward the torch tip recess 344. The body (including portions 302,304,306) of the conversion nozzle 300, and particularly the tapered end 314 of the inlet stem 302, prevents the second gas from the second gas source 354 from reaching the consumable thermal torch.

As shown, the passage 348, which can be referred to as a third passage, can also be connected to the first gas source for further receipt of the first gas and delivery thereof to the recess 344. Similar to the passage 348, the first tapered end 314 of the inlet stem 302 can block delivery of the low pressure oxygen from the passage 348 to the consumable thermal torch received in the recess 332. Though not shown, one or more appropriate regulators can be used between the passages 348,350 and the first gas source 352 for regulating or controlling the pressure of the first gas of the first gas source 354. Likewise, an appropriate regulator can be used between the passage 346 and the second gas source 354 for regulating or controlling the pressure of the second gas of the second gas source 354. In a conventional arrangement the first gas source can hold oxygen, which is delivered to the first passage 350 under high pressure and delivered to the third passage 348 under low pressure, and the second gas source 354 can hold acetylene gas.

More specifically, when the conventional two-gas torch 340 is used with a conventional nozzle (not shown), the conventional nozzle allows low pressure oxygen from the passage 348 to mix with acetylene gas from the passage 346 in a plurality of passageways circumferentially disposed about a main passage way, which itself communicates with passage 350 for receiving high pressure oxygen. However, when the conversion nozzle 300 is installed in the torch body 342, and particularly within the torch tip recess 344, gases from the passages 346,348 are effectively blocked and do not pass externally of the torch 340. Oxygen passing through passage 350, however, is delivered to the conversion nozzle 300 and therethrough via through passageway 312. Thus, oxygen can be delivered from the passage 350 to the first end portion 308 and pass along the passage 312 to the opposite, second end portion 309 of the nozzle 300 in which a consumable thermal torch can be held.

To install the nozzle 300 in the torch 340, the tapered end 314 of the inlet stem 302 is received in the torch tip recess 344. Then, the tip nut 304 is threaded into the recess 344 to secure the inlet stem 302 to the torch body 342. More specifically, the external threaded region 322 of the tip nut 304 threadedly engages internal threads 356 defined by the body 342 in the torch tip recess 344. Upon full installation, the head portion 326 of the tip nut 304 can rest adjacent an end wall 342a of the body 342 and the tip nut first end 320 can abut the shoulder 318.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the present disclosure.

1. An exothermic mini torch, comprising:
a torch holder assembly for holding a consumable thermal torch, said torch holder assembly including a body defining a recess into which said consumable thermal torch is inserted;
a passage defined in said body having a first end fluidly connected to a gas source and a second end fluidly connected to said recess for delivering gas from said gas source to said consumable thermal torch; and
a filter disposed between said gas source and said consumable thermal torch adjacent said second end of said passage for filtering said gas and preventing backflow of said gas into said body.

2. The exothermic mini torch of claim 1 wherein said filter is disposed approximately at a location disposed axially between said recess and said second end of said passage to filter all of said gas flowing from said passage into said recess.

3. The exothermic mini torch of claim 1 wherein said filter is a brass filter.

4. The exothermic mini torch of claim 1 wherein said recess includes an axially inward portion disposed immediately adjacent said second end of said passage, said filter cooperatively received in said axially inward portion and secured therein by a locking device.

5. The exothermic mini torch of claim 4 wherein said locking device includes a snap ring removably secured in a corresponding groove to axially lock said filter in said axially inward portion of said recess against a shoulder partially defining said axially inward portion.

6. The exothermic mini torch of claim 4 wherein said filter is has a diameter that substantially matches a diameter of said axially inward portion to allow said filter to be cooperatively disposed in said axially inward portion.

7. The exothermic mini torch of claim 1 further including an annular seal disposed between said consumable thermal torch and said body to direct said gas from said passage into said consumable thermal torch.

8. The exothermic mini torch of claim 7 wherein said annular seal is a rubber washer disposed axially between an end edge of said consumable thermal torch and a shoulder of said body partially defining said recess.

9. The exothermic mini torch of claim 7 wherein said annular seal is a rubber grommet received annularly about said consumable thermal torch and disposed radially between said consumable thermal torch and said body to seal therebetween.

10. The exothermic mini torch of claim 9 further including a press ring disposed axially adjacent said rubber grommet on a side thereof opposite said passage, said rubber grommet received in said recess and having a tapered radial side cooperatively received along a tapered radial surface defining said recess.

11. The exothermic mini torch of claim 9 further including a threaded retaining member threadedly received on said body for fixedly securing said consumable thermal torch to said body, said rubber grommet received in said recess and having a tapered radial side cooperatively received along a tapered radial surface defining said recess, said threaded retaining member in abutting relation to an axial side of said rubber grommet which causes said body tapered radial surface to act on said grommet tapered radial side to cause said rubber grommet to radially contract on said consumable thermal torch to fixedly secured said consumable thermal torch to said body as said threaded retaining member is threaded onto said body.

12. The exothermic mini torch of claim 1 wherein said torch holder assembly includes:
a collet annularly received about said consumable thermal torch, said collet including an tapered surface; and
a threaded retaining member threadedly received on said body, said threaded retaining member including a tapered surface that acts on said collet tapered surface as said threaded retaining member is threaded onto said body to cause said collet to radially contract on said consumable thermal torch to fixedly secure said consumable thermal torch to said body.

13. The exothermic mini torch of claim 1 further including
a valve assembly including a valve member disposed within said passage of said body for regulating gas flow thereby, said valve movable between a first position in which flow of said gas through said passage is prevented and a second position in which flow of said gas through said passage is substantially unrestricted by said valve member, a movable lever actuator pivotally attached to said body for moving said valve member between said first and second positions and allowing said valve member to be held at an intermediate position between said first and second positions.

14. A torch holder assembly for holding a consumable thermal torch, comprising:
a body defining a recess into which one end of the consumable thermal torch is received;
a passage defined through said body including a first end fluidly connected to a gas source and a second end fluidly connected to said recess for delivering gas from said gas source to said consumable thermal torch; and
a seal received in said recess and annularly disposed between an outer circumferential surface of the consumable thermal torch and a portion of said body forming said recess to direct said gas into the consumable thermal torch.

15. The torch holder assembly of claim 14 further including:
a threaded retaining member threadedly received on said body, said threaded retaining member applying an axial force on said seal as said threaded retaining member is threaded onto said body; and
a tapered engagement between said seal and said body that forces said seal to radially grip onto said outer circumferential surface when said axial force is applied to said seal by said threaded retaining member.

16. The torch holder assembly of claim 15 wherein said tapered engagement is formed between a tapered radial side of said seal and a cooperating tapered radial surface of said body forming said recess.

17. The torch holder assembly of claim 14 wherein said seal is a resilient grommet and the torch holder assembly further includes a nonresilient press ring disposed axially between said threaded retaining member and said resilient grommet.

18. The torch holder assembly of claim 17 wherein said resilient grommet includes a curved axial surface against which said press ring is disposed and said press ring includes a matching curved surface that distributes said axial force from said threaded retaining member across said curved axial surface of said grommet.

19. The torch holder assembly of claim 14 further including:
a brass filter disposed between said gas source and said consumable thermal torch adjacent said second end of said passage for filtering said gas and preventing backflow of said gas into said body.

20. The torch holder assembly of claim 19 wherein said brass filter is cooperatively received in an axially inward portion of said recess disposed immediately adjacent said second end of said passage, said brass filter secured in said axially inward portion by a snap ring removably secured in a corresponding groove defined in said body to axially lock said filter in said axially inward portion against a shoulder partially defining said axially inward portion.

21. A conversion nozzle for converting a two-gas torch to a single gas exothermic torch, the conversion nozzle comprising:
a body having a first end portion configured to be removably secured in a torch tip recess of a two-gas torch and a second end portion configured to hold a consumable thermal torch; and
a nozzle passage extending from said first end portion to said second end portion for transmitting one gas of the two-gas torch to the consumable thermal torch while preventing another gas of the two-gas torch from reaching the consumable thermal torch.

22. The conversion nozzle of claim 21 wherein said second end portion includes a torch holder assembly for holding the consumable thermal torch, said torch holder assembly including:
a torch holder body defining a recess into which one end of the consumable thermal torch is received, said recess fluidly connected to said nozzle passage; and
an annular seal disposed between the consumable thermal torch and said torch holder body to direct said one gas from said nozzle passage into the consumable thermal torch.

23. The conversion nozzle of claim 22 wherein said annular seal is a rubber washer disposed axially between an end edge of the consumable thermal torch and a shoulder of said torch holder body partially defining said recess.

24. The conversion nozzle of claim 22 wherein said annular seal is a rubber grommet received in said recess annularly about the consumable thermal torch and disposed radially between said consumable thermal torch and said torch holder body to seal between an outer circumferential surface of the consumable thermal torch and said torch holder body to direct said gas into the consumable thermal torch.

25. The conversion nozzle of claim 21 further including a brass filter disposed approximately at a location disposed axially between said recess and an end of said nozzle passage to filter said one gas flowing from said nozzle passage into the consumable thermal torch and preventing backflow of said one gas.

26. The conversion nozzle of claim 21 in combination with the two-gas torch, wherein said two-gas torch includes:
a two-gas torch body defining said torch tip recess;
a first passage defined in said two-gas torch body having a first end fluidly connected to a first gas source of said one gas and a second end fluidly connected to said torch tip recess for delivering said one gas from said first gas source to said torch tip recess, said body portion of said conversion nozzle delivering said one gas from said first gas source to the consumable thermal torch; and
a second passage defined in said two-gas torch body having a first end fluidly connected to a second gas source of said another gas and a second end fluidly connected to said torch tip recess for delivering said another gas from said second gas source to said torch tip recess, said body portion of said conversion nozzle preventing said another gas from said second gas source from reaching the consumable thermal torch.
